(19) United States
(12) Patent Application Publication
(10) Pub. No.: US 2018/0340808 A1
(43) Pub. Date: Nov. 29, 2018

(54) Torque Based Flowmeter Device and Method

(71) Applicant: Mingsheng Liu, Omaha, NE (US)

(72) Inventor: Mingsheng Liu, Omaha, NE (US)

(21) Appl. No.: 15/607,645

(22) Filed: May 29, 2017

(51) Int. Cl. G01F 7/00; G01L 5/26; G01F 3/12

(52) U.S. Cl. CPC G01F 7/00; G01F 1/07; G01F 3/12; G01L 5/26

(57) ABSTRACT

A device and principal method for measuring flow through a pipe for liquid and compressed gas. In an embodiment, the device is comprised of eccentric disk, rotation sensor, torque/stress sensor, coil spring, track rod, supports, and a digital processor. The processor determines the flow based on measured torque/stress, rotation, and other pre-determined parameters and relationship equations. The processor also provides data communication with other controllers and human-machine interface devices. In one simplified option, the arm may be fixed in one position and the rotation sensor is eliminated. In another simplified option, the torque sensor is removed. The compression of coil spring is measured by the rotation sensor. The torque is then determined using the coil spring performance and measured coil spring compression. The torque based flowmeter can be implemented to any industrial corrosive liquids, water, and gas with or without suspended solids.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The disclosed embodiments generally relate to flow measurements for water, liquid, oil, gas, and compressed air with or without suspended solids in commercial, agriculture, and industrial machinery and process.

### Description of the Related Art

Flowmeter is essential part for water, liquid, and gas flow measurement. Many flowmeters have been developed, which include orifice flowmeter, venturi flowmeter, nozzle flowmeter, pitot tube flowmeter, wedge flowmeter, vortex flowmeter, ultrasonic flowmeter, turbine flowmeter, and magnetic flowmeter. Based on the working principals, the flowmeters can be categorized as pressure based: orifice flowmeter, venturi flowmeter, nozzle flowmeter, pitot tube flowmeter, wedge flowmeter; vortex intensity based (Vortex flowmeter); light beam deformation based (Ultrasonic flowmeter); rotation speed based (turbine flowmeter); and magnetic field strength based (Magnetic flowmeter).

Flowmeters based on pressure measurement have been gradually phased out due to inaccuracy of the pressure measurement in the full flow range. A few researchers conducted researches to develop valve flowmeters based on valve position and the pressure difference across the valve; and to develop elbow flowmeters based on the measured pressure difference across the elbow. Both valve and elbow flowmeters are based on the measured pressure difference, its accuracy is poor and has no commercial potential.

Both Vortex and Turbine flow meters have sensors inside of the pipe. The sensors contact directly with the fluid. If the liquid has suspended solid, the meters can be easily damaged. If the liquid is corrosive, the sensor can be corroded easily as well. Both meters are limited to the application to no-corrosive clean liquid and gas.

Both ultrasonic and magnetic flowmeter have good accuracy and sensors have no direct contact to the liquid and gas. However, the cost of the flowmeter is high. Ultrasonic flowmeters also have strict requirement on the pipe conditions and installation. Pipe surface conditions and vibration have great negative impacts on the flowmeter performance.

Flow switch is another similar device although it does not measure flow accurately. A mechanical flow switch inserts a flexible sheet into the pipe. When the water velocity reaches certain speed, the flexible piece tilt toward the downstream of the pipe. Based on this movement, it detects the flow. The accurate position change is hard to detect. It is not suitable for accurate flow measurement.

In order to develop a high accuracy and in-expensive generic flowmeter for all applications, a torque based flowmeter device and principal method is described in this application. The primary element of the torque based flow meter is an eccentric disk located on the flow pass. The torque based flowmeter measures the torque and rotation of the eccentric disk. Based on the torque and the rotation, the flow rate can be determined accurately using digital processor. In one simplified option, the eccentric disk can be restricted to a fixed position and the rotation sensor can be removed. In another simplified option, the torque sensor can be removed. All sensors may also build into the flow pass and contact with fluid directly.

The proposed embodiment provides high accuracy flow measurement since both the torque and position can be measured accurately. Both torque and position sensors have very stable performance.

It is therefore one aspect of an embodiment to minimize the cost of the flowmeter due to both position and torque sensors are inexpensive, and the flowmeter body and eccentric disks are also inexpensive.

It is a further aspect of an embodiment to implement to all liquid or gas with or without suspended solids; and to any corrosive liquid where the eccentric disk shall be made by the same materials of the pipeline.

### SUMMARY OF THE INVENTION

The following summary of the invention is provided to facilitate an understanding of some of the innovative features unique to an embodiment of the present invention and is not intended to be a full description. A full appreciation of the various aspects of the invention can be gained by taking the entire specification, claims, drawings, and abstract as a whole.

In an embodiment, a torque based flowmeter device and principal method is provided. The torque based flowmeter consists of an eccentric disk, a coil spring, a torque sensor, a rotation sensor, and a digital processor which receives the signals from the torque and rotation sensors, provides data processing to determine the flow, and provides data communication with other controllers, devices, and/or human machine interfaces. In one simplified option, the arm and/or the eccentric disk is restricted to a fixed position, and the rotation sensor is removed. In another simplified option, the torque sensor is removed.

The above-described summary, features, and advantages of the present disclosure thus improve upon aspects of those systems and methods in the prior art designed to measure water, liquid, and gas flow.

### DRAWINGS REFERENCE NUMERALS

100 Schematic Principal Diagram of Torque Based Flowmeter
105 Flowmeter pipe section
110 Eccentric flowmeter disk
120 Rotation sensor
130 Torque sensor (stress sensor)
140 Coil spring
150 Track rod
160 Arm
180 Support
185 Digital processor
190 Support

### BRIEF DESCRIPTION OF THE DRAWINGS

It will be appreciated that for simplicity and clarity of illustration, elements illustrated in the following figures have not necessarily been drawn to scale. For example, the dimensions of some of the elements are exaggerated relative to other elements for clarity. Advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of the specification, wherein like reference numerals designate corresponding parts in the various figures, and wherein:

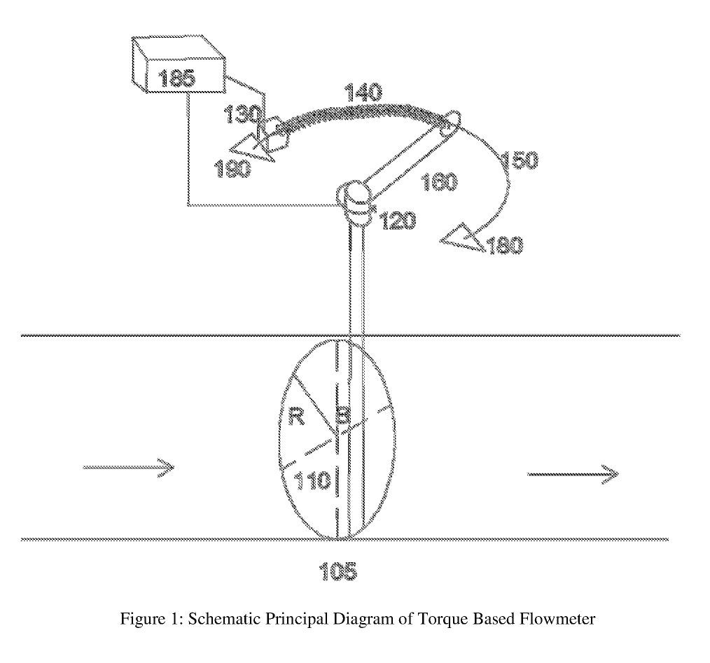

FIG. 1 is the schematic principal diagram of the system embodying the principles of the invention used for flow measurement for liquid, water, and gas with or without suspended solids.

### DETAILED DESCRIPTION

Before the present methods, systems, and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a”, “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. Nothing herein is to be construed as an admission that the embodiments described herein are not entitled to antedate such disclosure by virtue of prior invention.

The torque based flowmeter device and principal method 100 is illustrated in FIG. 1. The torque based flowmeter 100 can be implemented in a straight pipeline for liquid, water, and gas with or without suspended solids. The embodiment in FIG. 1 illustrates the torque based flowmeter 100 as comprised of pipe section 105, eccentric disk 110, rotation sensor 120, torque sensor (stress sensor) 130, coil spring 140, track rod 150, which is fixed on supports of 180 and 190, and a digital processor 185.

When liquid flows through the eccentric disk 110, a net torque is generated and transmitted through arm 160 and coil spring 140 to the torque sensor 130. The net torque varies with the flow. Both eccentric disk 110 and arm 160 rotate based on the strength of the torque. The rotation sensor 120 senses the degree of rotation. Both torque sensor 130 and rotation sensor 120 send the signal to the digital processor 185. The digital processor 185 determines the flow based on received rotation, torque, and other pre-determined parameters. In this configuration, the torque is maintained more or less the same while the eccentric rotation varies significantly with the flow rate. The flow resistance through the flow meter is remained at the same or minimum.

The coil spring, rotation sensor, and torque sensors may also be inside of the pipeline. The rotation may also be measured using the arm location.

The coil spring 140 may be removed. The track supports 180 and 190 are adjusted to contact the arm. The eccentric disk 110 location is fixed. The rotation sensor can, then, be eliminated. The flow rate can be determined based on the torque and the pre-determined parameters of the torques based flowmeter 100. This simplifies the flowmeter structure, and may reduce the cost of the flowmeter.

The stress sensor 130 may be removed. The compression of coil spring 140 is measured using the rotation sensor 120. The torque is then determined based on the measured coil compression. Finally, the flow is determined based on the measured rotation and torque. In this case, the coil spring 140 characteristics shall be critical.

It will be apparent to those skilled in the art that various modifications can be made in the system for flow measured based on torque and the rotation of the arm. Other embodiments will be apparent to those skilled in the art from consideration of the specification and practice of the disclosure in this application.

What is claimed is:

1. A torque based flowmeter device and principal method for measuring liquid flow rate and comprising:
at least one eccentric disk which generates net torque on the shaft, and can be any shape which generates net torque on its shaft.
at least one rotation sensor which measure the rotation of the eccentric disk.
at least one arm, which is sized to generate right range of stress or torque to improve the measurement accuracy.
at least one coil spring, which positions the eccentric disk in a pre-selected position under zero flow.
at least one stress/torque sensor to measure the force generated by both the coil spring and the torque generated by the eccentric disk.
at least two adjustable supports, which can limit and restrict the arm in a fixed position.

2. The torque based flowmeter of claim 1, wherein said liquid is chilled water.

3. The torque based flowmeter of claim 1, wherein said liquid is cooling water.

4. The torque based flowmeter of claim 1, wherein said liquid is city water.

5. The torque based flowmeter of claim 1, wherein said liquid is hot water.

6. The torque based flowmeter of claim 1, wherein said liquid is industrial process fluid materials, such as oil.

7. The torque based flowmeter of claim 1, wherein said liquid is compressed air.

8. The torque based flowmeter of claim 1, wherein said liquid is compressed industrial gas.

9. The torque based flowmeter of claim 1, wherein said liquid is gasoline.

10. The torque based flowmeter of claim 1, wherein said eccentric disk is a subject which can generate net torque on the shaft when the liquid flow through the subject.

11. The torque based flowmeter claim 1, wherein said coil spring, rotation sensor, and torque sensor may be installed inside of the pipeline.

12. The torque based flowmeter claim 2, where said rotation sensor or arm may be removed by setting the eccentric disk in a fixed position.

13. The torque based flow meter claim 2, wherein said eccentric rotation disk arm can be located in any given position.

14. The torque based flowmeter claim 2, wherein said coil spring can be removed when the arm is restricted to a fixed position.

15. The torque based flowmeter claim 3, where said stress sensor can be removed.

16. The torque based flowmeter claim 3, wherein the torque is determined based on the coil spring performance and the arm rotation.

17. The torque based flowmeter claim 4, wherein said the principal method of determining the flow comprising:
providing torque to the processor
providing the rotation position to the processor
provide the pre-determined parameters to the processor
provide pre-determined relationship of flow and these parameters.
